(19) United States
(12) Patent Application Publication
(10) Pub. No.: US 2025/0251345 A1
(43) Pub. Date: Aug. 7, 2025

(54) FLUORESCENCE MICROSCOPY IMAGING METHODS AND WAVEFRONT-CORRECTING DEVICES FOR IMPLEMENTING SUCH METHODS

(71) Applicants: IMAGINE OPTIC, Orsay (FR); ECOLE SUPERIEURE DE PHYSIQUE ET DE CHIMIE INDUSTRIELLES DE LA VILLE DE PARIS, Paris (FR); CENTRE NATIONAL DE LA RECHERCHE SCIENTIFIQUE (CNRS), Paris (FR); SORBONNE UNIVERSITE, Paris (FR); Paris Sciences et Lettres, Paris (FR)

(72) Inventors: Fabrice Harms, Orsay (FR); Xavier Levecq, Gif-Sur-Yvette (FR); Alexandra Fragaola, Orsay (FR)

(73) Assignees: IMAGINE OPTIC, Orsay (FR); ECOLE SUPERIEURE DE PHYSIQUE ET DE CHIMEIE INDUSTRIELLES DE LA VILLE DE PARIS, Paris (FR); CENTRE NATIONAL DE LA RECHERCHE SCIENTIFIQUE (CNRS), Paris (FR); SORBONNE UNIVERSITE, Paris (FR); Paris Sciences et Lettres, Paris (FR)

(21) Appl. No.: 18/854,429

(22) PCT Filed: Mar. 31, 2023
(86) PCT No.: PCT/EP2023/058579

§ 371 Date: Oct. 30, 2024

(30) Foreign Application Priority Data
Apr. 4, 2022 (FR) 2203064

(51) Int. Cl. G01N 21/64

(52) U.S. Cl. CPC G01N 21/6458; G01N 21/6402; G01N 2201/06113; G01N 2201/0636

(57) ABSTRACT

A method for fluorescence microscopic imaging of an object may be performed by means of a fluorescence microscopic imaging system with light sheet illumination. The method includes generating a line of light and scanning the line of light to generate a light sheet and further includes performing a wavefront analysis on an analysis field of the object. The method further includes applying spatial filtering of the fluorescence light, where the spatial filtering includes scanning a filtering element with respect to a fluorescence image of the line of light formed in a filtering plane of the filtering element. The scanning of the filtering element may be synchronized with the scanning of the line of light such as to obtain a superposition, at each instant, of the filtering element and the fluorescence image of the line of light.

### TECHNICAL FIELD OF THE INVENTION

The present description relates to methods for fluorescence microscopy imaging with light sheet illumination, wavefront correction devices adapted for implementing such methods, as well as microscopy imaging systems comprising such wavefront correction devices.

### PRIOR ART

In microscopy imaging, notably high-resolution imaging, the quality of the image in terms of resolution and contrast is directly related to the incident wavefront on the imaging detector, for example, a camera. The wavefront, i.e., the equal phase surface of a wave, is, in a microscopy imaging system, disrupted both by the optical defects introduced by optical components of the imaging system, such as, for example, manufacturing defects in the optical components, misalignments, refractive index mismatch between the immersion medium of the microscope objective and the object, and by the object itself. This is particularly true in the case of transparent or partially transparent biological objects, when producing an image corresponding to an in-depth plane in the object; indeed, in biological objects, the spatial distribution of the refractive index is inhomogeneous on the microscopic scale due to the complexity of the biological structures. The rays originating from various points of an in-depth plane in the object are therefore deviated by the successive layers traversed in the object. The wavefront originating from each of these points thus differs from a reference wavefront, for example, a flat or spherical wavefront and the corresponding microscopy image is degraded accordingly. Adaptive optics (AO) is a technique that allows a wavefront to be dynamically modified, and, particularly when the technique is used in an imaging system, that allows possible defects of the wavefront to be corrected at each point so as to restore the quality of the images produced by said system. When it is used in microscopy imaging, AO allows the imaging performance capabilities to be significantly improved by correcting at least some of the optical defects introduced by the optical system and the object of interest, according to various specific implementations, as described, for example, in, “Adaptive optics for fluorescence microscopy”, by M. J. Booth et al., [Ref. 1].

The methods for implementing AO in microscopy imaging that have been developed to date are all based on the use of a wavefront correction device that allows the phase of an optical wave to be locally modified. Known correction devices include, for example, deformable mirrors, liquid crystal modulators (or SLMs: “Spatial Light Modulator”), or even deformable lenses. A deformable mirror, for example, comprises a reflective membrane and a set of actuators allowing the membrane to be locally deformed in a controlled manner.

The methods for implementing AO in microscopy imaging nevertheless differ in terms of the methods for measuring optical defects, with a view to correction. A distinction can be made between two main categories for measuring optical defects: indirect measurement methods based on analyzing the image produced by the microscope by means of quality criteria representing the quality of the wavefront that led to the formation of said image, and direct measurement methods for measuring optical defects by means of wavefront analyzers, for example, Shack-Hartmann type analyzers.

The first approach (indirect measurement) allows simplified instrumental implementation, which is therefore less expensive due to the absence of a wavefront analyzer. However, it is based on a global optimization requiring the use of iterative algorithms, the convergence reliability, the execution speed and the calibration of which are limiting, particularly in the case of dynamic imaging of living objects.

Thus, notably for microscopy imaging of biological objects, the methods that are based on the direct measurement of optical defects associated with wavefront correction have demonstrated their ability to obtain very good correction of the optical defects introduced by the imaging system and the object, as well as a substantial improvement in the contrast and the resolution of the images. Such methods are described, for example, in the review article by N. Ji entitled, “Adaptive optical fluorescence microscopy” [Ref. 2].

However, the approach involving direct measurement of optical defects is still difficult to implement; indeed, a “source point” emitting a single wavefront is generally needed for this measurement. Currently, the most effective approaches involve optically inducing or isolating a light-emitting volume (also called “artificial star” or “guide star”) within the image. According to a first example, the artificial star is created by using fluorescent beads, the size of which is substantially equal to the diffraction limit of the microscope objective lens that is used, placed in the object of interest, as described in U.S. Pat. No. 855,730 B2 [Ref. 3], which requires substantial modification of the object. According to a second example described in published patent application US 2015/0362713 [Ref. 4], the artificial star is created using an ultrafast laser locally generating a 2-photon fluorescence emission volume in the object of interest.

These approaches thus demand complex implementation in microscopy imaging, whether this is in terms of the preparation of the object of interest or of the instrumental design. Moreover, the use of a source point as a wavefront source only makes the measurement of the optical defects induced by the object, and therefore the corresponding AO correction, valid on a field of view that is limited by the isoplanatic patch of the object, i.e., the area in the vicinity of the imaging plane of the object for which the optical defects vary by such a small amount that the corresponding image does not exhibit any significant degradation. However, most of the biological objects of interest in high-resolution microscopy are made up of multiple microscopic structures corresponding to significant phase fluctuations: the isoplanetic patch is generally limited to around a hundred square microns, which represents a significant limitation for studying large structures with high spatio-temporal resolution, such as, for example, for studying neural networks in the field of neuroimaging.

Most recently, an AO method has been proposed in a microscopy imaging system with “light sheet” illumination (or “light sheet microscopy”) that dispenses with the use of a source point for measuring optical defects. Such a method is described in the article by K. Lawrence et al., entitled, “Scene-based Shack-Hartmann wavefront sensor for light-sheet microscopy” [Ref. 5]. To this end, a Shack-Hartmann type wavefront analyzer is proposed in which each microlens of the analyzer forms an image of an extended object, hence the name extended source wave front analysis device. The wavefront analysis is undertaken by means of intercorrelations between the images formed by the various microlenses, allowing a two-dimensional map of the local gradients (or local slopes) of the wavefront to be obtained.

Even more recently, a fluorescence microscopy imaging system has been proposed with light sheet illumination comprising an improved extended source wavefront analysis device. Please refer to published patent application WO 2020/157265 [Ref. 6]. The wavefront analysis device described in [Ref. 6] notably comprises a two-dimensional detector with a detection plane and a two-dimensional arrangement of microlenses arranged in an analysis plane, with each microlens being configured to form an image on the detection plane of an object located in a focal plane of the microscope objective lens, with a given analysis field, when the analysis device is connected to the microscopy imaging system. The wavefront analysis device further comprises a field diaphragm optically conjugate with the detection plane of the two-dimensional detector, with the field diaphragm allowing the analysis field of each microlens to be limited.

The wavefront analysis device described in [Ref. 6] allows the precision of the analysis to be significantly improved compared to the known devices of the prior art, while dispensing with the generation of an artificial guide star. Indeed, the field diaphragm thus arranged in the wavefront analysis device allows the size of the image formed by each microlens in the vicinity of the detection plane to be controlled and allows the overlap between two images formed by two adjacent microlenses to be limited, yet without limiting the size of the field imaged by the microscopy imaging system to which said wavefront analysis device is connected.

However, the applicants have highlighted an additional limitation when using an extended source wavefront analysis device as described in [Ref. 6], with this additional limitation being explained with reference to FIG. 1. FIG. 1 highly schematically illustrates a wavefront analysis device comprising a matrix 120 of microlenses, with some of the microlenses (121-125) being shown, with the wavefront analysis device being arranged at the exit of a microscope objective lens 110 comprising an exit pupil 111 in a pupil plane PP. The microlenses are arranged in a pupil plane optically conjugated with the pupil plane PP and are configured to generate, in a detection plane 130 of a two-dimensional detector of the wavefront analysis device, images 131-135 of an object 100 that intercepts an object plane PO of the microscope objective lens. In FIG. 1, the plane of the microlenses is shown coincident with the pupil plane PP for the sake of simplification.

As illustrated in FIG. 1, the vast majority of fluorescence microscopy imaging systems with light sheet illumination generate a light sheet 101 that is very thick over a wide field of view, notably its thickness is greater than the depth of field of the microscope objective lens over the complete field of view of the microscope objective lens, with said depth of field being identified by the strip 115 in FIG. 1. Indeed, it is known that, in order to obtain a light sheet with a substantially constant thickness over a wide field of view, this light sheet has to be created by means of an optical system with a low numerical aperture, lower than the numerical aperture of the imaging objective lens, as described, for example, in [Ref. 7], pp. 122-125. Furthermore, in the case of scattering samples, which is the case of biological objects to varying degrees, the effective thickness of the light sheet is increased due to the scattering.

However, each microlens has a numerical aperture that is smaller than the numerical aperture of the microscope objective lens of the microscopy imaging system. For example, for a wavefront measurement device comprising a two-dimensional arrangement of 100 microlenses intercepting the pupil of the microscope objective lens of the microscopy imaging system, the numerical aperture of each microlens will be 10 times lower than that of the microscope objective lens if the focal length of each microlens is similar to the focal length of the microscope objective lens. Consequently, the depth of field of each microlens (represented by the strip 140 in FIG. 1) is significantly greater than the depth of field of the microscope objective lens, 100 times greater in the aforementioned example, with the numerical aperture and the depth of field being connected according to the following formula:

$$[ Math 1 ]$$

$$D 0 F = \frac{λ}{{NA}^{2}}$$

where λ represents the imaging wavelength, NA represents the numerical aperture and DOF represents the depth of field.

Thus, when the extended source wavefront measurement device is connected to a fluorescence microscopy imaging system with light sheet illumination, as illustrated in FIG. 1, each microlens makes an image typically corresponding to the entire thickness of the light sheet, i.e., makes a projection in a plane of all the fluorescent photons originating from the light sheet. As a result, the computation of intercorrelations between the images formed by the microlenses of the wavefront measurement device is carried out on a section of the object that is significantly greater than the depth of field of the imaging objective lens for the majority of fluorescence microscopy imaging systems with light sheet illumination.

This phenomenon, which is highlighted by the applicants, is responsible for two main problems. On the one hand, measuring aberrations in this case corresponds to an average measurement of the aberrations present in the effective thickness of the light sheet. This feature can be particularly problematic in the case of highly inhomogeneous objects, for which the axial isoplanetic patch, i.e., the extension along the optical imaging axis for which the aberrations are identical, is very low. Since the measured aberrations do not only represent aberrations corresponding to the imaging plane in such a case, their use in an adaptive optics system then does not allow the best possible correction to be obtained. On the other hand, when the object is made up of fluorescent elements distributed over three dimensions in the thickness of the light sheet, the images produced by the microlenses of the extended source wavefront analyzer correspond to a plenoptic imaging system, or “light-field imaging system”. In such a system, each image corresponds to an image of the object viewed at a different viewing angle. In the case of a 3-dimensional object as illustrated in FIG. 1, the difference in viewing angle results in images 131-135 that are not similar due to the projection of the photons originating from the object over the entire thickness of the light sheet at different angles. These relative differences between the images are likely to affect the result of the intercorrelation computation between the images when measuring aberrations, and consequently can generate significant measurement errors.

The aim of the present description is to notably propose a fluorescence microscopy imaging method with light sheet illumination and a fluorescence microscopy imaging system with light sheet illumination equipped with a wavefront analysis device that overcomes all or some of the aforementioned limitations.

### SUMMARY OF THE INVENTION

Throughout the present description, the term “comprise” means the same as “include” or “contain”, and is inclusive or open and does not exclude other elements that are not described or represented.

Furthermore, throughout the present description, the term “approximately” or “substantially” is synonymous with (means the same as) having a lower and/or upper margin of 10%, for example, 5%, of the respective value.

According to a first aspect, the present description relates to a method for fluorescence microscopy imaging of a volumetric and fluorescent object by means of a fluorescence microscopy imaging system with light sheet illumination, with said system comprising an imaging microscope objective lens with a pupil in a pupil plane and an optical axis, the method comprising:
illuminating the object with a light sheet through an illumination path comprising an illumination device, wherein the illumination comprises generating a line of light and scanning the line of light in an illumination plane substantially perpendicular to the optical axis of the imaging microscope objective lens in order to generate a light sheet, wherein a focal plane of said imaging microscope objective lens is included in said light sheet, and wherein said light sheet generate an emission of fluorescence light from the object;
generating, through an imaging path comprising said imaging microscope objective lens and an imaging detector comprising an imaging detection plane, at least one first fluorescence image of an optical section of the object superimposed on the focal plane of said imaging microscope objective lens, wherein said at least one first fluorescence image is generated in a spectral imaging band;
analyzing a wavefront of the fluorescence light emitted by the object through an analysis path comprising said imaging microscope objective lens and a wavefront analysis device, wherein the wavefront analysis device comprises a two-dimensional detector with an analysis detection plane conjugate with said focal plane of the imaging microscope objective lens and a two-dimensional arrangement of microlenses, arranged in an analysis plane conjugate with said pupil plane, wherein said analysis of a wavefront comprises:
   each microlens generating, on the analysis detection plane, a fluorescence image of a given analysis field of the object, located in a focal plane of the imaging microscope objective lens, wherein said fluorescence image is generated in a spectral analysis band;
   spatially filtering the fluorescence light emitted by said analysis field by means of a spatial filtering device comprising a filtering element arranged in a filtering plane optically conjugate with the analysis detection plane, wherein the spatial filtering comprises a scan of said filtering element relative to a fluorescence image of said line of light formed in said filtering plane, synchronized with said scan of the line of light, so as to obtain a superposition of said filtering element and of said fluorescence image of the line of light at each instant;
   processing the fluorescence images generated by the microlenses by means of a processing unit in order to determine a two-dimensional map of a characteristic parameter of the wavefront in said analysis plane;
correcting, based on the two-dimensional map of a characteristic parameter of the wavefront, at least a portion of the optical defects between said optical section of the object and said imaging detection plane, by means of a wavefront modulation device comprising a correction plane conjugate with the pupil plane.

Throughout the present description, fluorescence is understood to be the emission of light from an object resulting from photon absorption from light excitation in a given spectral absorption band. The emission of fluorescence light can result from a linear mechanism with one photon or from a non-linear mechanism with two or more photons, with this mechanism resulting from the interaction of the absorbed light with a fluorescent element forming the object or with a fluorescent element added to the object, such as, for example, in the case of a biological object, a fluorescent protein.

A volumetric and fluorescent object thus comprises any object comprising microscopic structures, provided with intrinsic fluorescence properties or made fluorescent by adding a “marker”. A volumetric and fluorescent object comprises, for example, a biological object such as a cell, a cell culture, a biological tissue, an animal, with these biological objects being provided with fluorescence properties, whether they are intrinsically formed by the object or are induced by adding fluorescent elements. Among the volumetric and fluorescent objects of interest, the fluorescent neural structures of an animal brain within the context of neuroimaging studies can be cited in particular.

A “fluorescence image” of the object or of a portion of the object in a given imaging plane therefore is an image of the object or of the portion of the object, formed in the spectral fluorescence band, by all the optical components arranged between the object and the imaging plane.

A wavefront within the meaning of the present description is the equal phase surface of a light wave.

According to one or more embodiments, a characteristic parameter of the wavefront comprises a local gradient (or local slope) over two dimensions of the wavefront intercepted in the analysis plane.

According to one or more embodiments, a characteristic parameter of the wavefront comprises a local deviation of the wavefront intercepted in the analysis plane relative to a reference wavefront corresponding to a light wave that would not have been subject to optical defects, for example, a flat wavefront. The two-dimensional map of said local deviations of the wavefront relative to a reference wavefront can be obtained from the two-dimensional map of the local slopes of the wavefront.

According to one or more embodiments, determining said two-dimensional map comprises determining variations in the positions of the fluorescence images generated by the microlenses, wherein the variation in position of a fluorescence image generated by a microlens is measured relative to a reference position of a reference image, wherein the variation in position is determined by an operation between said image and said reference image, and wherein said operation is selected from among: an intercorrelation, a phase correlation, a sum of squared differences operation.

The applicants have demonstrated that the method thus described allows, compared with the known methods of the prior art, a significant improvement to be provided in terms of the precision of the wavefront analysis, and thus provides better imaging quality, while dispensing with the generation of an artificial star.

Indeed, the imaging method according to the first aspect comprises an extended source wavefront analysis, i.e., comprising processing on fluorescence images generated by the microlenses that are larger than the point spread functions of the microlenses. Moreover, the spatial filtering implemented in the wavefront analysis allows confocal filtering of the fluorescence light, i.e., only the fluorescence light originating from an optical section of the object that is thinner than the light sheet is analyzed by the wavefront analysis device, avoiding any errors in processing the fluorescence images.

Within the meaning of the present description, the term “microlens” refers to any optical focusing element with lateral dimensions (i.e., measured in the analysis plane) that are less than or equal to 5 mm, having a focal length that is less than or equal to 20 mm and a pupil size that is less than or equal to 5 mm. A microlens can include, for example, a transparent material with two diopters, at least one of which is not flat, with the non-flat diopter being, for example, a convex diopter, for example, a spherical diopter.

According to one or more embodiments, said microlenses of the microlens matrix are identical, for example, arranged as a two-dimensional matrix.

According to one or more embodiments, said microlenses of the array of microlenses are contiguous and have a square pupil.

According to one or more embodiments, the filtering element comprises a movable slit and the spatial filtering of the fluorescence light emitted by said analysis field comprises a transverse movement of said slit, synchronized with the scan of the line of light.

A transverse movement is a movement in a plane substantially perpendicular to the optical axis of the wavefront analysis device, considered in the vicinity of said slit.

According to one or more embodiments, the filtering element comprises a fixed slit and the spatial filtering device further comprises a set of optical components including at least one first rotatable mirror, wherein the set of optical components is configured to generate a fluorescence image of the line of light on the slit. The spatial filtering of the fluorescence light emitted by said analysis field then comprises rotating said at least one first movable mirror, synchronized with the scan of the line of light, in order to superimpose said slit and said fluorescence image of said line of light at each instant.

According to one or more embodiments, the device for illuminating the illumination path comprises a laser emitting device for emitting a light beam and an optical illumination system with an optical illumination axis, wherein the optical illumination system is configured to generate a line of light from said light beam parallel to the optical illumination axis, wherein the light sheet is generated by scanning the line of light in a direction perpendicular to the optical illumination axis. For example, the illumination device comprises a DSLM (Digitally Scanned Laser light sheet fluorescence Microscopy) type device as described in [Ref. 7], pp. 143-144.

According to one or more embodiments, the device for illuminating the illumination path comprises a laser emitting device for emitting a light beam and an optical illumination system with an optical illumination axis configured to generate a line of light from said collimated light beam perpendicular to the optical illumination axis, wherein the light sheet is generated by scanning the line of light. For example, the illumination device comprises an ASLM (Axially Swept Light Sheet Microscopy) type device as described in [Ref. 8].

According to one or more embodiments, the light sheet is generated by scanning the line of light in a direction parallel to the optical illumination axis. In other embodiments, the light sheet is generated by scanning the line of light in a direction that is inclined relative to the optical illumination axis.

According to one or more embodiments, the spectral imaging band is identical to the spectral analysis band.

According to one or more embodiments, the spectral imaging band is different from the spectral analysis band. This can be advantageous if the intention is to benefit from a maximum amount of light power on the imaging path, without a portion of the light power that is useful for imaging being sent over the analysis path.

According to a second aspect, the present description relates to a wavefront correction device configured to be connected to a fluorescence microscopy imaging system with light sheet illumination, wherein said fluorescence microscopy imaging system comprises an imaging path comprising an imaging microscope objective lens with a pupil in a pupil plane and an optical axis, and an illumination path comprising an illumination device configured to scan a line of light in an illumination plane substantially perpendicular to the optical axis in order to generate a light sheet.

The wavefront correction device according to the second aspect comprises:
a wavefront analysis device comprising:
a two-dimensional detector comprising an analysis detection plane;
a two-dimensional arrangement of microlenses, arranged in an analysis plane, wherein each microlens is configured to generate, on the analysis detection plane when the wavefront correction device is connected to the microscopy imaging system, a fluorescence image of a given analysis field of the object located in a focal plane of the imaging microscope objective lens, with said fluorescence image being generated in a spectral analysis band;
a spatial filtering device configured to spatially filter fluorescence light emitted by said analysis field when the wavefront correction device is connected to the microscopy imaging system, wherein the spatial filtering device comprises a filtering element arranged in a filtering plane optically conjugate with the analysis detection plane and scanning means configured to scan said filtering element relative to a fluorescence image of said line of light formed in said filtering plane, synchronized with said scan of the line of light, so as to obtain a superposition of said filtering element and of said fluorescence image of the line of light at each instant;
a processing unit configured to determine a two-dimensional map of a characteristic parameter of the wavefront in said analysis plane based on all the images formed by the microlenses; wherein the wavefront correction device further comprises:
a wavefront modulation device comprising a correction plane, configured to correct at least a portion of the optical defects between said optical section of the object and said imaging detection plane (PP₁) based on the two-dimensional map of a characteristic parameter of the wavefront when the wavefront correction device is connected to the microscopy imaging system;
a first optical relay system configured to optically conjugate the pupil plane, the correction plane and the analysis plane when the wavefront correction device is connected to the microscopy imaging system;
a second optical relay system configured to optically conjugate the focal plane of the imaging microscope objective lens, the analysis detection plane, the imaging detection plane and the filtering plane when the wavefront correction device is connected to the microscopy imaging system.

According to one or more embodiments, the filtering element of the spatial filtering device comprises a movable slit, and the scanning means are configured to generate a transverse movement of said slit, synchronized with the scan of the line of light.

According to one or more embodiments, said movable slit is formed by a movable optomechanical element configured to transmit or reflect fluorescence light.

According to one or more embodiments, said movable slit is formed by addressing a group of one or more rows (or columns) of a spatial intensity modulation device.

According to one or more embodiments, the filtering element comprises a fixed slit and the spatial filtering device further comprises a set of optical components including at least one first rotatable mirror, and wherein:
the set of optical components is configured to generate a fluorescence image of the line of light on the slit; and
the scanning means are configured generate a rotation of at least one first movable mirror, synchronized with the scan of the line of light, in order to superimpose said slit and said fluorescence image of said line of light at each instant.

According to one or more embodiments, the scanning means are configured to generate a rotation of a second movable mirror of the set of optical components, synchronized with the scan of the line of light and the scan of the first movable mirror, allowing the fluorescence image to be reconstituted, said fluorescence image being produced by the temporal succession of the fluorescence images of the line of light produced by scanning the line of light, in an intermediate focal plane conjugate with the analysis detection plane.

In other embodiments, the set of optical components comprises at least one or more folding mirrors configured so that said first movable mirror allows the fluorescence image to be reconstituted, said fluorescence image being produced by the temporal succession of the fluorescence images of the line of light produced by scanning the line of light, in an intermediate focal plane conjugate with the analysis detection plane.

According to one or more embodiments, the width of the slit ranges between a minimum value equal to the diffraction limit, advantageously twice the diffraction limit, of the imaging microscope objective lens multiplied by the optical magnification between the focal plane of the imaging microscope objective lens and the filtering plane in which the slit is arranged, and a maximum value equal to the width of the Rayleigh range corresponding to a Gaussian beam generating the fluorescence line of light and multiplied by the optical magnification between the focal plane of the imaging microscope objective lens and the filtering plane in which the slit is arranged.

According to one or more embodiments, the wavefront modulation device comprises a deformable mirror generally made up of a membrane and of actuators allowing the axial position of said membrane to be locally modified. The wavefront modulation device can also comprise a spatial light modulator (SLM), generally made up of a two-dimensional arrangement of liquid crystal cells coupled to electrodes allowing the refractive index of said cells to be locally modified. The wavefront modulation device can also comprise a deformable lens generally made up of active components allowing the shape and/or the thickness of said lens to be locally modified.

Correcting optical defects, or correcting the wavefront, is understood to mean locally modifying the phase of the wave in the correction plane intended to obtain a reference wavefront. Depending on the intended use of the wavefront correction method, the reference wavefront can be a flat wavefront, as is the case, for example, for optimizing the performance capabilities of an imaging system, or a specific wavefront.

According to one or more embodiments, the device according to the second aspect further comprises a beam splitter element, arranged between the wavefront modulation device and the wavefront analysis device and configured to split the wavefront analysis device and the imaging path when the wavefront correction device is connected to the microscopy imaging system.

According to one or more embodiments, the beam splitter element is dichroic, i.e., it allows the incident light to be split over a first spectral band in reflection and over a second spectral band different from the first spectral band in transmission.

According to one or more embodiments, the dichroic beam splitter element allows the two spectral bands, respectively the imaging and analysis bands, to be split toward the imaging path and toward the analysis path.

According to one or more embodiments, the two-dimensional detector comprises a two-dimensional arrangement of elementary detectors and a point spread function of a microlens comprises between 0.2 and 2 elementary detectors in one direction. The dimension of a point spread function of a microlens in one direction is defined by the distance separating the first 2 minima of intensity located on either side of the maximum intensity. The applicants have shown that this particular configuration represented a good compromise between the wavefront measurement precision and the size of the analysis field.

According to one or more embodiments, determining said two-dimensional map comprises determining variations in the positions of the images formed by the microlenses, wherein the variation in position of an image formed by a microlens is measured relative to a reference position of a reference image, wherein the variation in position is determined by an intercorrelation operation between said image and said reference image.

According to a third aspect, the present description relates to a system for fluorescence microscopy imaging of a volumetric and fluorescent object with light sheet illumination comprising:
an imaging path configured to generate at least one first image of an optical section of the object in a spectral imaging band, wherein said imaging path comprises an imaging microscope objective lens with a pupil in a pupil plane and an imaging detector comprising an imaging detection plane, wherein said optical section is superimposed on a focal plane of said imaging microscope objective lens;
an illumination path of the object comprising an illumination device configured to scan a line of light in an illumination plane substantially perpendicular to the optical axis of the imaging microscope objective lens;
an analysis and correction path comprising said imaging microscope objective lens and a wavefront correction device according to the second aspect, configured to correct at least a portion of the optical defects between said optical section of the object and said imaging detection plane based on the two-dimensional map of a characteristic parameter of the wavefront.

According to one or more embodiments, the device for illuminating the illumination path comprises a laser emitting device for emitting a light beam and an optical illumination system with an optical illumination axis, wherein the optical illumination system is configured to generate a line of light from said light beam parallel to the optical illumination axis, and wherein the light sheet is generated by scanning the line of light in a direction perpendicular to the optical illumination axis.

According to one or more embodiments, the device for illuminating the illumination path comprises a laser emitting device for emitting a light beam and an optical illumination system with an optical illumination axis configured to generate a line of light from said collimated light beam perpendicular to the optical illumination axis, wherein the light sheet is generated by scanning the line of light.

According to one or more embodiments, the imaging detector comprises a two-dimensional detector with a two-dimensional arrangement of elementary detectors or “pixels”, wherein the detector is configured to read pixels per row or per column at the same time as scanning the line of light. Reading per row or per column is understood to mean sequentially reading a group of one or more rows or a group of one or more columns. For example, the imaging detector is a rolling shutter type camera.

According to one or more embodiments, the imaging path further comprises a unit for processing the signals originating from the imaging detector. Of course, in practice, the processing units of the analysis path and of the imaging path can be combined within the same unit.

### BRIEF DESCRIPTION OF THE FIGURES

Further advantages and features of the invention will become apparent upon reading the description, which is illustrated by the following figures:

FIG. 1, already described, schematically shows the formation of fluorescent images by microlenses of a wavefront analysis device according to the prior art, connected to a fluorescence imaging system with light sheet illumination;

FIG. 2 illustrates a diagram of an example of a fluorescence imaging system with light sheet illumination, according to the present description.

Detailed description of the invention;

FIG. 3A illustrates a diagram of an illumination path of a fluorescence imaging system with light sheet illumination according to the present description, according to a first embodiment;

FIG. 3B illustrates a diagram of an illumination path of a fluorescence imaging system with light sheet illumination according to the present description, according to a second embodiment;

FIG. 3C illustrates a diagram of an illumination path of a fluorescence imaging system with light sheet illumination according to the present description, according to a third embodiment;

FIG. 4A illustrates a first example of a spatial filtering device of a wavefront analysis device according to the present description, with the filtering element of the spatial filtering device comprising a movable slit formed by a movable optomechanical element configured to transmit or reflect fluorescence light.

FIG. 4B illustrates a second example of a spatial filtering device of a wavefront analysis device according to the present description, with the filtering element of the spatial filtering device comprising a movable slit formed by addressing a group of one or more rows (or columns) of a spatial intensity modulation device;

FIG. 5A illustrates a first example of a spatial filtering device with a fixed slit and means for scanning a fluorescence image of the line of light on the slit, in a wavefront analysis device according to the present description;

FIG. 5B illustrates a second example of a spatial filtering device with a fixed slit and means for scanning a fluorescence image of the line of light on the slit, in a wavefront analysis device according to the present description;

FIG. 6 shows a diagram illustrating the synchronization between the various paths, according to an embodiment of the method according to the present description.

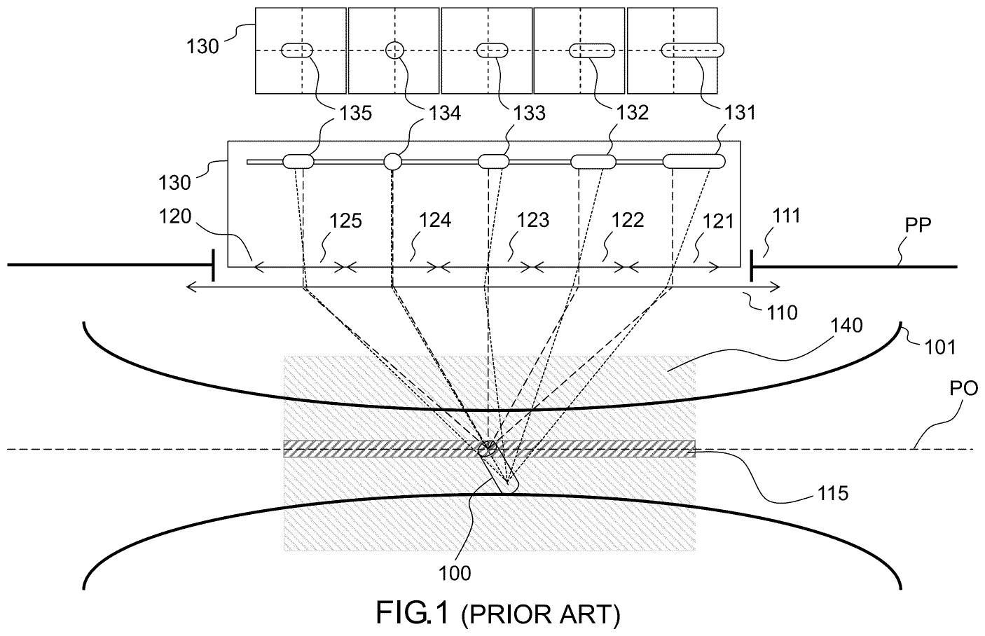

### DETAILED DESCRIPTION OF THE INVENTION

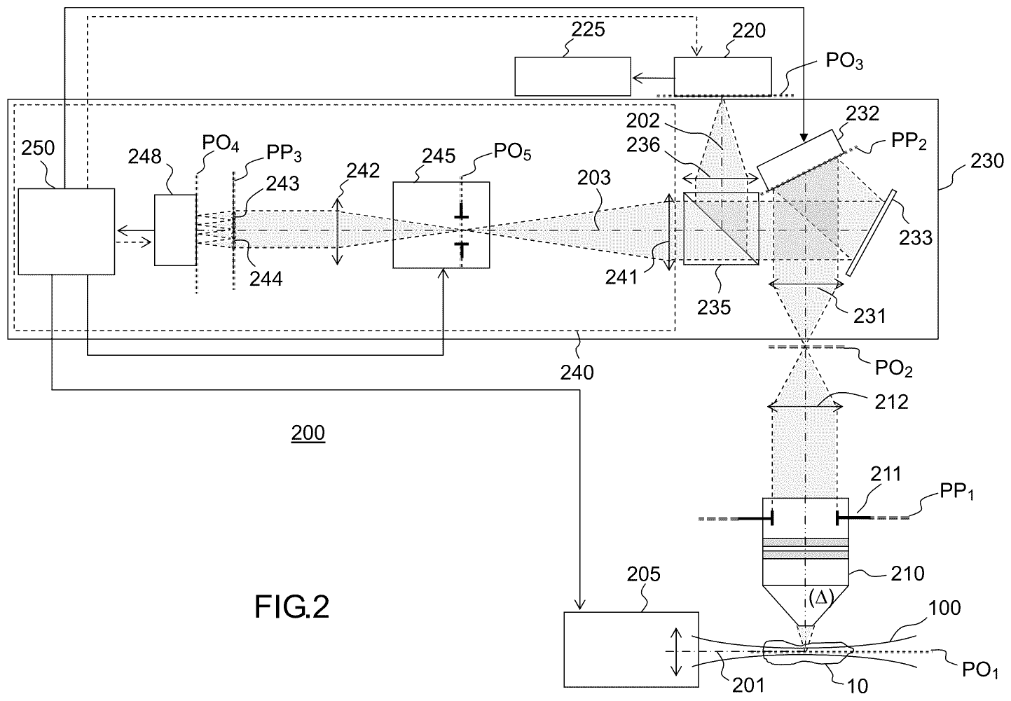

FIG. 2 schematically illustrates an example of a microscopy imaging system 200 with light sheet illumination for implementing an example of methods for microscopy imaging of a volumetric and fluorescent object 10, according to the present description.

The microscopy imaging system 200 illustrated in FIG. 2 comprises an illumination path 201 configured to illuminate the object by light sheet illumination, an imaging path 202 configured to generate at least one first image of an optical section of the object in a spectral imaging band, and an analysis and correction path 203.

The imaging path 202 comprises an imaging microscope objective lens 210 with a pupil in a pupil plane PP₁ and an imaging detector 220 comprising an imaging detection plane arranged in a plane PO₃ conjugate with a focal plane PO₁ of the imaging microscope objective lens, with said optical section being superimposed on the focal plane PO₁ of the imaging microscope objective lens. As illustrated in FIG. 2, the imaging path can further comprise a processing unit 225 for processing signals originating from the imaging detector 220. The imaging detector 220 is, for example, a two-dimensional detector, for example, a CCD (Charge Coupled Device) camera or a high sensitivity CMOS (Complementary Metal Oxide Sensor) camera, such as, for example, sCMOS cameras, for example, a rolling shutter type camera.

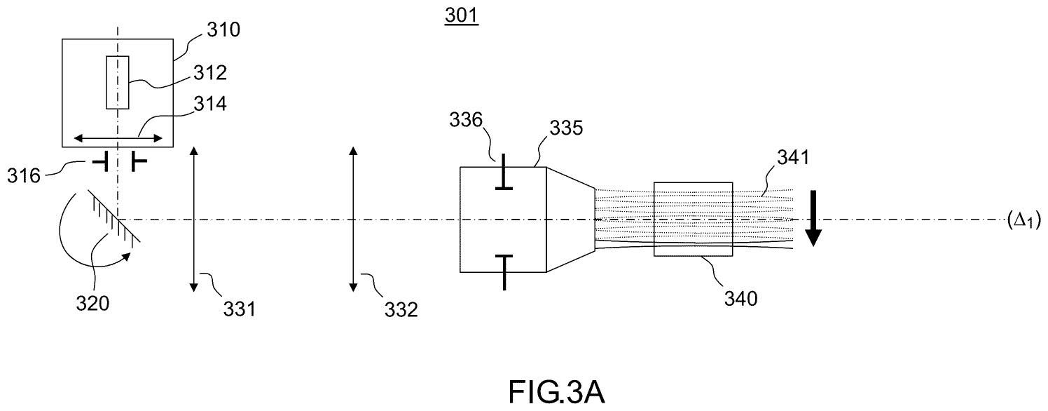

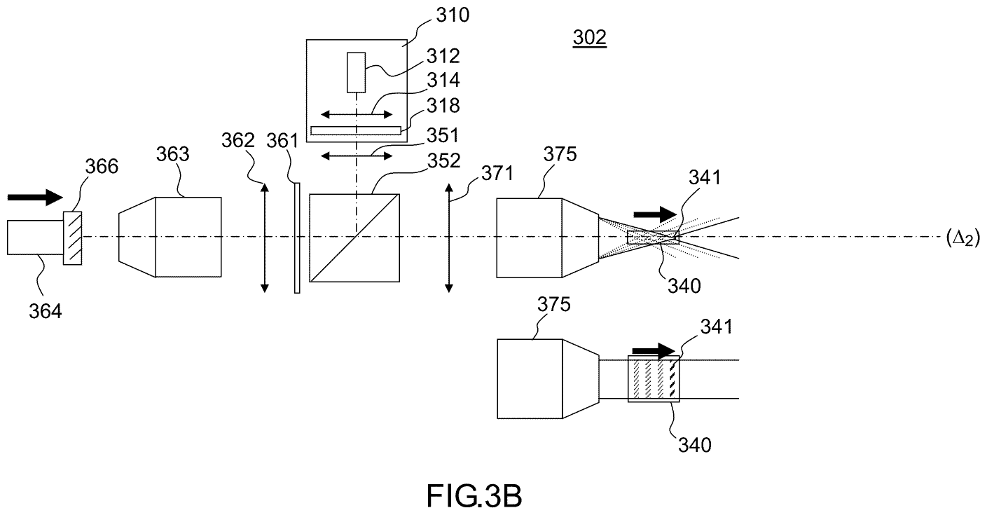

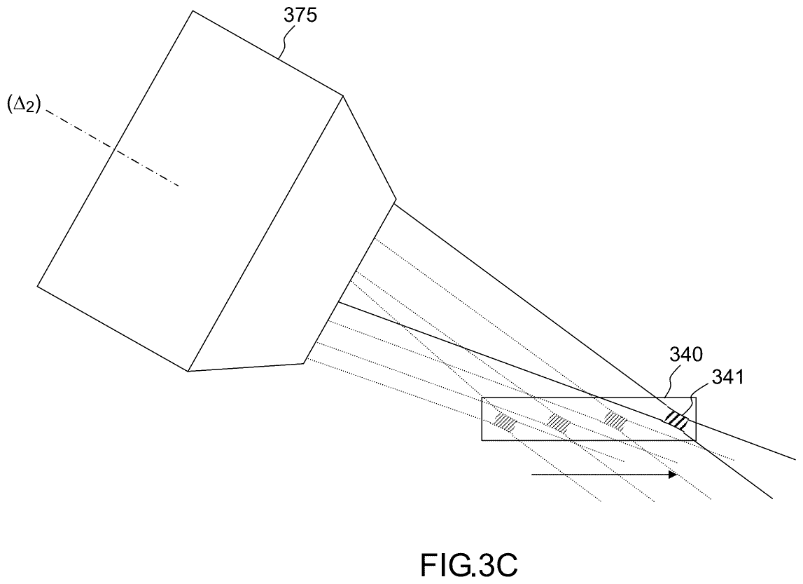

The illumination path 201 comprises an illumination device 205 configured to scan a line of light in an illumination plane substantially perpendicular to the optical axis of the imaging microscope objective lens, in order to generate a light sheet 100, with the focal plane PO₁ of said imaging microscope objective lens being included in said light sheet, with said light sheet being configured to generate an emission of fluorescence light, in one or more spectral bands, including the spectral imaging band. Examples of an illumination device will be described with reference to FIG. 3A, FIG. 3B, FIG. 3C.

The analysis and correction path 203 comprises said imaging microscope objective lens and a wavefront correction device 230 configured to correct, based on the two-dimensional map of a characteristic parameter of the wavefront, at least some of the optical defects between said optical section of the object and said imaging detection plane PP₁.

Thus, in embodiments as described with reference to FIG. 2, the microscopy imaging system 200 is modular, made up of three main modules, namely a “microscope” module comprising the illumination device 205 and the imaging microscope objective lens 210, a detection module with the imaging detector 220 and an analysis and correction module comprising the wavefront correction device 230. In practice, the wavefront correction device 230 can be configured to be connected to an existing microscopy imaging system comprising the microscope and the detection module. In such an existing microscopy imaging system, the detection plane of the imaging detector 220 is generally positioned in an intermediate focal plane PO₂ of an objective lens 212 (or tube lens). In order to connect the wavefront correction device 230 to the existing imaging system, the imaging detector 220 simply needs to be moved so that the detection plane is located in a focal plane PO₃ conjugate with the focal plane PO; of the imaging microscope objective lens, as can be seen in FIG. 2. The wavefront correction device 230 can include mechanical interfaces (not shown) for connecting said wavefront correction device 230 to the microscope and to the imaging detector. Such a modular arrangement has the advantage of being adaptable to existing microscopy imaging systems with light sheet illumination.

In other embodiments, the microscopy imaging system is not modular and is designed and optimized as a whole, with all the paths 201, 202, 203, without seeking to connect a correction device to an existing system.

In all cases, the wavefront correction device 230 comprises a wavefront analysis device 240 comprising a two-dimensional detector 248 with an analysis detection plane PO₄ and a two-dimensional arrangement 243 of microlenses 244, arranged in an analysis plane PP₃. Each microlens is configured to generate a fluorescence image of a given analysis field of the object on the analysis detection plane, in a spectral analysis band, with the analysis field being located in the focal plane PO₁ of the imaging microscope objective lens.

In some embodiments, the spectral imaging band is identical to the spectral analysis band. A fluorescence light with the same spectral band is then detected on each of the analysis and imaging paths.

In other embodiments, the spectral imaging band can differ from the spectral analysis band. This can be advantageous if the intention is to benefit from a maximum amount of light power on the imaging path, without a portion of the light power being sent over the analysis path. To this end, it is possible, for example, to illuminate the object with a light sheet that includes two distinct excitation spectral bands so as to cause the object to emit fluorescence light in two distinct fluorescence spectral bands, with one forming the spectral imaging band and the other forming the spectral analysis band. The wavefront correction device 230 also comprises a processing unit 250 configured to determine a two-dimensional map of a characteristic parameter of the wavefront in said analysis plane based on all the images formed by the microlenses.

According to one or more embodiments, the two-dimensional detector comprises a two-dimensional arrangement of elementary detectors and a point spread function of a microlens comprises between 0.2 and 2 elementary detectors in one direction. The dimension of a point spread function of a microlens in one direction is defined by the distance separating the first 2 minima of intensity located on either side of the maximum intensity. The applicants have shown that this particular configuration represented a good compromise between the wavefront measurement precision and the size of the analysis field.

For example, a characteristic parameter of the wavefront comprises a local gradient (or local slope) over two dimensions of the wavefront intercepted in the analysis plane. According to another example, a characteristic parameter of the wavefront comprises a local deviation of the wavefront intercepted in the analysis plane relative to a reference wavefront corresponding to a light wave that would not have been subject to optical defects, for example, a flat wavefront. The two-dimensional map of said local deviations of the wavefront relative to a reference wavefront can be obtained from the two-dimensional map of the local slopes of the wavefront.

Furthermore, determining the two-dimensional map of a characteristic parameter of the wavefront can comprise determining variations in the positions of the fluorescence images generated by the microlenses, with the variation in position of a fluorescence image generated by a microlens being measured relative to a reference position of a reference fluorescence image, with the variation in position being determined, for example, by an intercorrelation operation between said fluorescence image and said reference fluorescence image. The local slopes of the wavefront are determined from the variations in position of the fluorescence images.

An intercorrelation between two two-dimensional images I₁(x,y) and I₂(x,y) acquired by a two-dimensional detector and thus representing the light intensity values of the images I₁ and I₂ at the point of coordinates (x, y) is known as the result of the following computation:

$$[ Math 2 ]$$

$$c ( x , y ) = {\sum }_{s} {\sum }_{t} {I}_{1} ( s , t ) {I}_{2} ( x + s , y + t )$$

with s and t being 2 variables describing a spatial deviation along the 2 axes of the two-dimensional image. It is preferably possible to carry out a normalized correlation operation in order to reduce a possible influence of the average difference in intensity between the 2 images.

The variation in position between said fluorescence image and said reference fluorescence image can be determined by other operations that are known to a person skilled in the art, for example, and in a non-exhaustive manner: a phase correlation operation, a sum of squared differences operation.

A phase correlation between two images is known as the result of the following computation, using the same notations as before:

$$[ Math 3 ]$$

$${c}_{p} ( x , y ) = {ℱ}^{- 1} \{ \frac{ℱ \{ {I}_{1} \} o {ℱ}^{*} \{ {I}_{2} \}}{\vert ℱ \{ {I}_{1} o {ℱ}^{*} \{ {I}_{2} \} \vert} \}$$

where [symbol] denotes the Fourier transform operator, o denotes the Hadamard product operator, and ∥ denotes the absolute value operator.

A sum of squared differences between two images is known as the result of the following computation, using the same notations as before:

$$[ Math 4 ]$$

$$SSD ( x , y ) = {\sum }_{s} {\sum }_{t} {[ {I}_{1} ( x + s , y + t ) - {I}_{2} ( s , t ) ]}^{2}$$

In these various examples, the difference in position of a fluorescence image generated by a microlens relative to a reference position of a reference fluorescence image is determined, for example, by determining the position of the maximum value over 2 dimensions of the figure resulting from the intercorrelation or phase correlation operation, or by determining the position of the minimum value over 2 dimensions of the figure resulting from the sum of squared differences operation.

The processing unit 250 is generally configured to implement computation and/or processing steps implemented in methods according to the present application.

In general, when the present description refers to computation or processing steps notably for implementing method steps, it is understood that each computation or processing step can be implemented by software, hardware, firmware, microcode or any suitable combination of these technologies. When software is used, each computation or processing step can be implemented by computer program instructions or software code. These instructions can be stored or transmitted to a computer-readable storage medium (or processing unit) and/or can be executed by a computer (or processing unit) in order to implement these computation or processing steps. Thus, the processing unit 250 and the processing unit 225 can be consolidated within the same unit, for example, a computer.

The wavefront correction device 230 also comprises a wavefront modulation device 232 comprising a correction plane PP₂ that is configured to correct at least some of the optical defects between the optical section of the object and the imaging detection plane PP₁ based on the two-dimensional map of a characteristic parameter of the wavefront. A first optical relay system allows the pupil plane PP₁ of the imaging microscope objective lens 210, the correction plane PP₂ and the analysis plane PP₃ to be optically conjugated. In the example of FIG. 2, which represents a modular microscopy imaging system, the first optical relay system notably comprises the objective lenses 231, 241, 242. Furthermore, a second optical relay system allows the object focal plane PO₁ of the imaging microscope objective lens 210 and the detection plane PO₃ to be optically conjugated. In the example of FIG. 2, the second optical relay system notably comprises the objective lenses 231, 236. Of course, other arrangements are possible to ensure the optical conjugations between the various pupil planes and between the various focal planes.

The wavefront modulation device 232 can include, in a known and by no means limiting manner, a deformable mirror that is generally made up of a membrane and of actuators allowing the axial position of said membrane to be locally modified. The wavefront modulation device can also include a spatial light modulator (SLM), which is generally made up of a two-dimensional arrangement of liquid crystal cells coupled to electrodes allowing the refractive index of said cells to be locally modified.

As illustrated in FIG. 2, the wavefront correction device 230 can also include a beam splitter element 235, arranged between the wavefront modulation device 232 and the wavefront analysis device 240 and configured to split the wavefront analysis path 203 of the wavefront analysis device 240 and the imaging path 202, when the wavefront correction device is connected to the microscopy imaging system.

In some embodiments, the beam splitter element 235 is dichroic, i.e., it allows the incident light to be split over a first spectral band in reflection and over a second spectral band different from the first spectral band in transmission. The dichroic property of the splitter element is of interest when the spectral imaging band is different from the spectral analysis band.

According to the present description, the wavefront analysis device 240 further comprises a spatial filtering device 245 configured to spatially filter fluorescence light emitted by said analysis field when the wavefront correction device is connected to the microscopy imaging system.

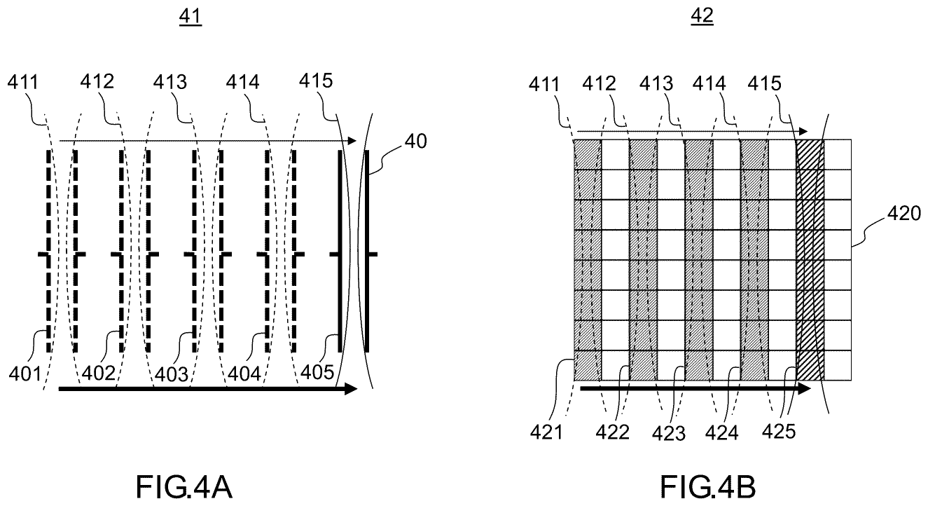

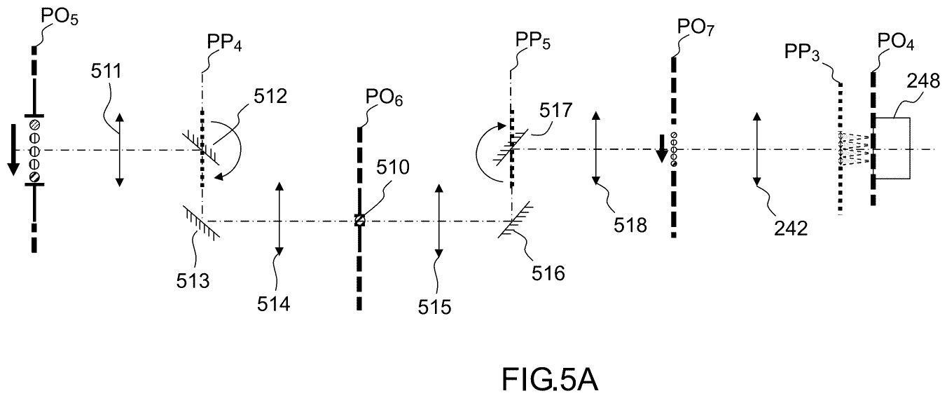

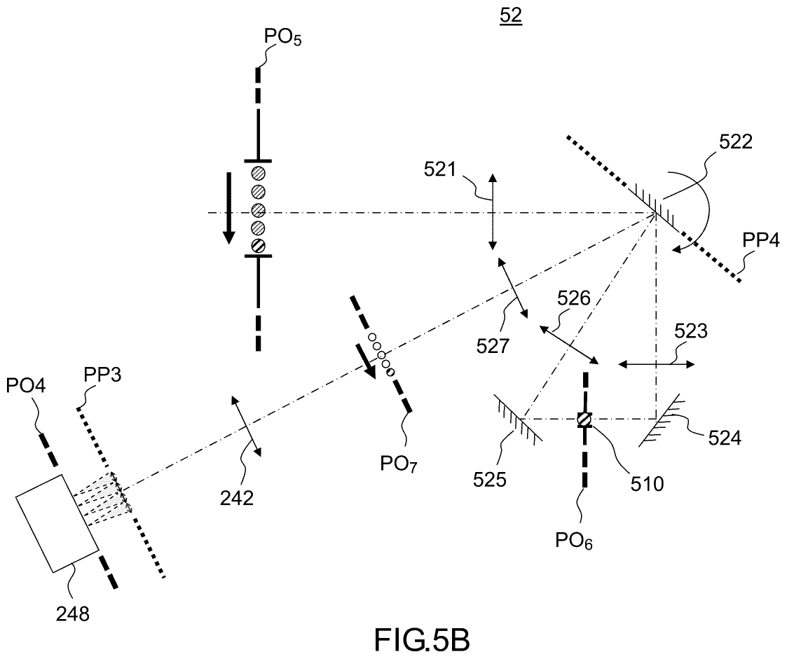

The spatial filtering device, examples of which are described in detail with reference to FIG. 4A, FIG. 4B, FIG. 5A, FIG. 5B, comprises a filtering element arranged in a filtering plane optically conjugate with the analysis detection plane PO₄. It further comprises scanning means configured to scan the filtering element relative to a fluorescence image of the line of light formed in said filtering plane. Scanning the filtering element relative to the fluorescence image of the line of light is synchronized with the scan of the line of light so as to obtain a superposition of the filtering element and of the fluorescence image of the line of light at each instant. The applicants have demonstrated that the scan of the filtering element relative to the fluorescence image of the line of light synchronized with the scan of the line of light allows confocal filtering of the fluorescence light, i.e., only the fluorescence light originating from an optical section of the object that is thinner than the light sheet is analyzed by the wavefront analysis device. Such confocal filtering avoids any errors in processing fluorescence images generated by the microlenses, which results, compared with the known methods of the prior art, in a significant improvement in the precision of the wavefront analysis, as well as better imaging quality.

FIG. 3A schematically illustrates a first embodiment of an illumination device 301 of a fluorescence imaging system with light sheet illumination according to the present description.

In this example, the illumination device comprises a laser emitting device 310 for emitting a light beam, more specifically a collimated light beam in this example. The laser emitting device 310 comprises at least one first spatially coherent light source 312, for example, a laser source, for example, a laser diode, emitting fluorescent markers of the object at an excitation wavelength, as well as a collimating lens 314. A diaphragm 316, for example, an iris diaphragm, also can be provided in order to control the diameter of the light beam output from the emitting device 310. The illumination device 301 also comprises an optical illumination system with an optical illumination axis Δ₁, with the optical illumination system being configured to generate a line of light 341 from the light beam, with the line of light being parallel to the optical illumination axis Δ₁, and an angular scanning device 320, for example, a galvanometric mirror, configured to scan the line of light 341 in a direction perpendicular to the optical illumination axis Δ₁ in order to generate the light sheet 340.

In this example, the optical illumination system comprises a focusing optic 335, for example, a microscope objective lens, that defines the optical illumination axis Δ₁.

In this example, the optical illumination system also comprises an optical relay system, comprising optics 331, 332 configured to relay, with the angular scanning device 320, the light beam originating from the laser emitting device 310 toward the focusing optic 335. The optics 331 and 332 form an optical conjugation between the plane in which the angular scanning of the angular scanning device 320 is carried out, for example, the reflective surface of a galvanometric mirror, and the back focal plane 336 of the focusing optic 335, for example, a microscope objective lens, the back focal plane can be coincident or close to the pupil of the microscope objective lens. The optics 331 and 332 advantageously form an afocal system, so that the collimated beam originating from the laser emitting device 310 is collimated at the input of the focusing optic 335.

The optics 331 and 332 are typically achromatic lenses, for example, doublets, allowing both optical aberrations but also chromatic aberrations to be minimized.

With achromatic optics 331, 332, it is possible to use a laser emitting device 310 emitting a light beam whose main wavelength can be adjusted in a wide spectral band, typically of several hundred nanometers, or a light beam with several main wavelengths.

The main wavelength of the light beam output from the emitting device 310 can be carried out, for example, by changing the source 312, or by using several laser sources of different wavelengths (not shown in FIG. 3A) selected by means of a beam splitter.

The use of several sources of different main wavelengths allows, for example, the fluorescence of a sample provided with fluorescent markings with different properties to be excited. For example, in the case of imaging fluorescent cells, it is possible to specifically prepare the cells by providing them with fluorescent proteins located over specific structures. According to the same example, it is thus possible, with suitable excitation light, to obtain a fluorescence signal from such cells that specifically originates from the core, for example, when the mCherry fluorescent protein is specifically present in the nuclear structures, and a signal specifically originating from cytoplasm, for example, when the GFP protein is specifically present in the tubulin. The mCherry protein emits a red fluorescence light when it is excited by a laser with a wavelength of 561 nm, for example, and the GFP protein emits a green fluorescence light when it is excited by a laser with a wavelength of 488 nm, for example. Thus, in order to view these various cellular structures, for example, using a camera collecting the fluorescence signal, two laser sources with different main wavelengths can be provided, with these two laser sources in some embodiments being able to excite the fluorescent proteins at the same time when they are combined by means of a suitable dichroic beam splitter. The device for measuring and correcting a wavefront as described in the present invention can also benefit from the use of several laser sources for exciting several fluorescent markings of a sample. Indeed, the fluorescence signal originating, for example, from a biological object that has benefited from specific preparation as described above, for example, is generally a low amplitude signal. Thus, most of the time it is worthwhile minimizing the losses of the fluorescence signal that is used in order to produce an image of the object of interest. In the case of a wavefront correction device according to the present description, as described in FIG. 2, for example, when the fluorescence signal is split by a conventional beam splitter 235, i.e., only selecting the proportion of light transmitted and reflected according to the intensity of the incident light and not according to other features such as, for example, its wavelength or its polarization, a portion of the fluorescence signal that is useful for producing the image of the object of interest is used to analyze the wavefront using the sub-set 240, and is thus lost in terms of the production of the image. In order to eliminate these losses, it is thus possible to specifically prepare the object of interest by adding a fluorescent marking emitting fluorescence light over a spectrum that is shifted from the spectrum of the fluorescence light that is useful for generating the image. In this case, an additional laser source in the laser emitting device 310, specifically exciting the fluorescence in a spectral analysis band that is shifted relative to a spectral imaging band, allows a fluorescence signal to be provided that advantageously can be directed toward the wavefront analysis device 240 using a dichroic beam splitter 235, without inducing, or by minimizing, a loss of the fluorescence signal that is useful for producing the image of the object of interest. In these various examples using several sources with different wavelengths, selecting achromatic optics 331 and 332 ensures that the focusing features of the beam 341 originating from the optic 335 are substantially identical.

The angular scanning device 320 is typically a galvanometric mirror, allowing the reflecting surface of the mirror to rotate along an axis of rotation that is perpendicular to the axis Δ₁, for example, with the axis of rotation being located on the surface of the mirror, for example. The angular scanning carried out by the angular scanning device 320 thus allows the line of light 341 to move in a direction perpendicular to Δ₁, which direction is represented by the thick line arrow in FIG. 3A.

The light sheet 340 is defined, according to some embodiments, in terms of its width by the amplitude of the angular scanning carried out by the angular scanning device 320, and in terms of its length by the distance along Δ₁ where the thickness of the line of light is substantially constant, for example, by a factor of almost 2. The center of the light sheet 340 is thus typically defined along the first axis in terms of the position of the line of light corresponding to the middle of the amplitude of the scanning device 320 and along the second axis in terms of the position of the waist of the line of light 341. Indeed, when the source 312 is a laser source, the propagation features of the line of light 341 are those of a Gaussian beam, Thus, the numerical aperture of the beam 341 is particularly defined by the diameter of the beam at the input of the optic 335, with this diameter being able to be adjusted by the diaphragm 316. It is thus possible to control some features of the light sheet produced by the illumination path 301 by adjusting the size of the diaphragm 316, such as, for example, the thickness of the light sheet, as well as the size of the light sheet 340 for which the light sheet has a substantially constant thickness.

Specific implementations of the illumination path 301 that allow improvements, for example in terms of image resolution, are possible. For example, it is possible to use ultrafast laser sources 312 to generate a non-linear fluorescence signal such as a 2- or 3-photon signal, allowing the thickness of the line of light emitting a fluorescence signal to be minimized. It is also possible to implement specific spatial shaping of the line of light 341, for example, by using Bessel or Airy type beams allowing a focusing line with a constant thickness to be generated over a significant propagation distance, typically larger than the waist size of a Gaussian beam.

The general operating principle of an illumination path 301 corresponding to the present description, as well as more details concerning its operation in a linear or non-linear fluorescence state, as well as for various properties of the line of light 341 associated with particular shaping operations, are described in [Ref. 7], for example, pp. 143-153. The illumination approach according to the present description is typically called Digitally Scanned Laser Light-Sheet Fluorescence Microscopy or DSLM.

FIG. 3B schematically illustrates a second embodiment of an illumination device 302 of a fluorescence imaging system with light sheet illumination according to the present description. The illumination device described with reference to FIG. 3B is of the Axially-Swept Light-Sheet Fluorescence Microscopy or ASLM type. The details for implementing this illumination approach, as well as examples of fluorescence images produced when this illumination approach is carried out in a light sheet microscope, are described in [Ref. 8], for example.

As in the case of FIG. 3A, the illumination device comprises a laser emitting device 310 for emitting a beam, for example, a collimated light beam. The laser emitting device 310 comprises, as explained above, one or more light sources 312, for example, a laser source of the laser diode type, as well as a collimating lens 314. A single source 312 is shown in FIG. 3B. Several different main wavelength sources that are combined using a dichroic splitter can be used to excite several fluorescence signals, as described with reference to FIG. 3A. Similarly, it is also possible to use various types of laser source 312, such as, for example, an ultrafast laser source allowing a non-linear fluorescence signal to be generated. In the example of FIG. 3B, the emitted light beam is polarized, for example. The laser emitting device can thus include a half-wave plate or a polarizer 318, disposed at the output of the source 312, so as to define a polarization axis of the emitted light beam.

The illumination device 302 further comprises, in the example of FIG. 3B, a cylindrical lens 351 for generating an astigmatic beam, i.e., a beam for which the light is focused in the focal plane of the lens 351 along a line. A polarizing beam splitter 352 allows the astigmatic beam to be reflected toward a ¼ wave plate 361, then toward a lens 362 allowing the focusing line to be conjugated in the back focal plane of a first microscope objective lens 363. The first microscope objective lens 363, defining an optical axis Δ₂, forms a focusing line on the reflective surface of a mirror 366, with the mirror 366 being able to be moved along the optical axis Δ₂ by means of a linear translation system 364, typically a motorized and controllable translation system such as a piezoelectric actuator or even a stepper motor. An optical relay system of the remote focusing type, in this example including the first microscope objective lens 363 and a second microscope objective lens 375 with an optical axis collinear to the optical axis of the first microscope objective lens 363, as well as lenses 362 and 371, allows the light beam reflected onto the mirror 366 to be relayed at the exit of the objective lens 375. For this optical system, the lenses 362 and 371 typically form an afocal and telecentric system, with the image focal point of the lens 362 coinciding with the object focal point of the lens 371, and the lenses 362 and 371 being arranged so as to optically conjugate between the respective pupil planes of the objective lenses 363 and 375, for example, by positioning the pupil plane of the objective lens 363 on the object focal plane of the lens 362 and the pupil plane of the objective lens 375 on the image focal plane of the lens 371. The two microscope objective lenses 363 and 375 are positioned in the opposite direction along the optical axis Δ₂. The specific feature of this remote focusing type of optical system lies in its ability, when the optics are specifically selected, to produce the image of an object located in front of one of the microscope objective lenses in front of the other microscope objective lens, and in such a way as to be practically free of aberrations, even if the object is not located in the focal plane of the objective lens. Thus, in the case of FIG. 3B, the focusing line created by the objective lens 363 on the reflecting surface of the mirror 366 is imaged downstream of the second microscope objective lens 375, along the line of light 341. In addition, when the mirror 366 is moved along the optical axis Δ₂ using a linear translation device 364, for example, the properties of the remote focusing type relay system allow the image 341 of the focusing line to move along the optical axis Δ₂, in the same direction as the mirror 366, without significantly modifying the spatial features of the focusing line. The respective movements of the mirror 366 and of the focusing line 341 are shown in FIG. 3B using two thick arrows located above the linear translation device 364 and the light sheet 340. An additional figure, as a top view, schematically shows the movement of the focusing line of light 341 along the axis Δ₂ during the movement of the mirror 366. The amplitude of the movement of the focusing line of light 341 resulting from the movement of the mirror 366 allows the size of the light sheet 340 created by the movement of the line 341 along the axis Δ₂ to be defined, with the size of the light sheet 340 in the other direction being defined by the width of the line 341, which itself is directly related to the size of the beam output from the laser emitting device 310. As in FIG. 3A, a diaphragm can be added when the size of the beam at the output of the laser emitting device 310 needs to be controlled, which diaphragm is not shown in FIG. 3B and is shown by reference numeral 316 in FIG. 3A.

Other implementations of an illumination path 302 according to an ASLM type principle are possible, in particular by using systems for controlling the focusing of the beam originating from the second microscope objective lens 375, that differ from the remote focusing system described above, such as, for example, the use of deformable lenses, as is described in [Ref. 9], for example.

FIG. 3C schematically shows a variation of the embodiment of an illumination device of a fluorescence imaging system with light sheet illumination as illustrated in FIG. 3B.

As described above, FIGS. 3A and 3B illustrate illumination paths for which, when they are implemented in a fluorescence imaging system with light sheet illumination, the microscope objective lens of the imaging path is typically positioned perpendicular to the microscope objective lens 335 (respectively 375) of the illumination device. Indeed, since for most fluorescence imaging systems with light sheet illumination the excitation light sheet is located in a plane perpendicular to the optical axis of the microscope objective lens of the imaging path so as to make the light sheet correspond to the focal plane of the microscope objective lens of the imaging path, an implementation as illustrated in FIGS. 3A and 3B involves positioning the optical axes Δ₁ and Δ₂ perpendicular to the optical axis Δ of the microscope objective lens of the imaging path. In these embodiments, the maximum size of the light sheet along the axes 41 and Δ₂, respectively, is limited by the extension, i.e., the distance between the last optical surface of the microscope objective lens 335 (respectively 375) and its focusing plane, thus limiting the maximum size of the objects that can be imaged using such illumination paths. FIG. 3C illustrates another embodiment in which the optical axis Δ₂ of the microscope objective lens 375 of the illumination device is not perpendicular to the optical axis of the imaging lens. It is then possible to create an excitation light sheet by scanning a focusing line of light 341 produced according to a method similar to that described in FIG. 3B, for example, with this focusing line of light 341 not being scanned in a direction parallel to Δ₂, but in a direction that allows a light sheet 340 to be defined in a plane perpendicular to the optical axis of the imaging microscope objective lens, by means of a device for scanning the line of light combining both a modification of the axial position of the focusing line of light according to Δ₂, as described in FIG. 3B, but also an angular modification of the exit beam of the microscope objective lens 375, using a galvanometric mirror (not shown in FIG. 3C), for example. This alternative approach thus allows a light sheet to be created that is larger than the limit of the size of the light sheets obtained by virtue of the illumination devices described with reference to FIG. 3A and FIG. 3B, and thus allows images of larger objects to be generated. The details for implementing the lighting approach described in FIG. 3C are described in [Ref. 10], for example.

In some embodiments, and notably when a DSLM or ASLM type illumination device as described above are used, it will be possible to use a detector 220 for the fluorescence imaging path 202 of the fluorescence imaging system with light sheet illumination (see FIG. 2), which detector is configured to only select the light originating from the line of light 341, and thus to filter the fluorescence light originating from other portions of the excitation beam for generating the line of light 341. For example, a two-dimensional rolling shutter type camera can be used. In such a camera, reading the pixels of the camera per row or per group of rows (or per column or per group of columns depending on the orientation) is synchronous with the scan of the line of light 341.

FIGS. 4A, 4B, 5A, 5B illustrate, by way of examples, embodiments of devices for spatially filtering the fluorescence light emitted by the analysis field, with the spatial filtering devices being part of wavefront analysis devices according to the present description. In these examples, the spatial filtering device comprises a filtering element arranged in a filtering plane optically conjugate with the analysis detection plane PO₄ of the wavefront analysis device (see FIG. 2), with the spatial filtering comprising a scan of the filtering element relative to a fluorescence image of the line of light, formed in the filtering plane, with the scan being synchronized with the scan of the line of light so as to obtain a superposition of the filtering element and of a fluorescence image of the line of light at each instant. The line of light is scanned, for example, using one of the methods described with reference to FIG. 3A, 3B or 3C.

FIGS. 4A and 4B schematically illustrate two first embodiments of a spatial filtering device comprising a movable slit, with the spatial filtering of the fluorescence light emitted by the analysis field comprising a transverse movement of the slit, synchronized with the scan of the line of light.

More specifically, in the example of FIG. 4A, the spatial filtering device comprises a movable slit 40 that synchronously moves when the line of light is scanned. Thus, FIG. 4A illustrates the superposition of the fluorescence image of the line of light at various instants, schematically shown by the lines 411-415, with the slit whose position is schematically shown at the same instants by the lines 401-405. The arrows in FIG. 4A respectively indicate the movements of the fluorescence image of the line of light (thin line) and of the slit (thick line).

The slit 40 is positioned in a filtering plane optically conjugate with the focal plane PO₁ of the imaging microscope objective lens when the wavefront correction device (230, FIG. 2) is connected to the microscopy imaging system.

The spatial filtering device further comprises means for transversely moving the slit 40, i.e., in a plane perpendicular to the optical axis, with said movement means comprising, for example, a motorized translation system, for example, a stepper or piezoelectric type motor.

The slit 40 can be a transmission slit, and comprises a transparent surface describing a line with a given width, for example, surrounded by a frame that is opaque to fluorescence light, or that reflects, and comprises a reflective surface describing a line with a given width, for example.

The largest dimension of the slit 40, i.e., the length, can be selected so as to limit the size of the image produced by each microlens of the wavefront analysis device in the direction corresponding to the length of the slit, so as to avoid any overlap of the images produced by the various microlenses of the wavefront analysis device in said direction. The smallest dimension of the slit 40, i.e., the width, can be selected so as to reach a compromise between the confocal volume defined by this width, i.e., the volume in the sample in which the photons are not blocked by the slit, and can be detected by the wavefront analysis device, the loss of light generated by the spatial filtering, which loss is directly proportional to the width of the slit, and the inability of the slit to filter, particularly when it is too narrow, any aberrations of the fluorescence light that are to be measured by the wavefront analysis device in order to be subsequently corrected by the wavefront modulation device. In order to address this compromise, the applicants have shown that a slit width can advantageously range between a minimum value and a maximum value. The minimum value is equal to the diffraction limit, for example, advantageously twice the diffraction limit, of the imaging microscope objective lens multiplied by the optical magnification between the focal plane of the imaging microscope objective lens and the filtering plane where the slit 40 is arranged. The maximum value is equal, for example, to the width of the Rayleigh range corresponding to the Gaussian beam generating the line of fluorescence light and multiplied by the optical magnification between the focal plane of the imaging microscope objective lens and the filtering plane where the slit 40 is arranged.

In the example of FIG. 4B, the spatial filtering device comprises a spatial intensity modulation device 420 arranged in a filtering plane optically conjugate with the focal plane PO₁ of the imaging microscope objective lens when the wavefront correction device (230, FIG. 2) is connected to the microscopy imaging system. The spatial intensity modulation device 420 is controlled at the same time as the line of light is scanned in order to address a group of one or more rows (or columns) so as to form a slit that is superimposed on a fluorescence image of the line of light formed in the filtering plane at each instant.

For example, the spatial intensity modulation device 420 comprises a matrix of micromirrors or a “Digital Micromirror Device” DMD. A DMD comprises a two-dimensional matrix of micromirrors individually controlled in terms of orientation at several angles. An incident beam on a DMD thus can be reflected with an intensity pattern that is directly related to the individual positions of the micromirrors. It is thus possible to control the DMD so as to orient a group of one or more rows (or columns) of micromirrors in a direction that allows the wavefront analyzer to collect the light reflected by this group of one or more rows (or columns), with the group of one or more rows (or columns) of micromirrors being moved over time at the same time as the line of light is scanned and in the same direction as the movement of the line of light.

Synchronizing the control of the DMD with the scan of the line of light thus allows, as is illustrated in FIG. 4B, the fluorescence image of the line of light (411-415) to be superimposed at each instant with the group of one or more rows (or columns) of micromirrors of the DMD that is addressed, with a group of one or more rows (or columns) being represented by the columns 421-425. In FIG. 4B, the arrows respectively indicate the movements over time of the fluorescence image of the line of light (thin line) and of the group of one or more rows (or columns) that is/are addressed (thick line).

The lengths and widths of the group of one or more rows (or columns) of micromirrors can be selected according to the same criteria as those described with reference to FIG. 4A. However, for a DMD type spatial intensity modulation device, since the size of an individual micromirror generally cannot be custom made, it can be worthwhile finely adjusting the efficiency of the spatial filtering system so as to adjust the magnifications derived from the various groups of optics in a wavefront correction device according to the present description.

FIGS. 5A and 5B schematically illustrate two second embodiments 51, 52, of a spatial filtering device comprising a filtering element, in this case with a fixed slit, referenced 510 in FIG. 5A and FIG. 5B and arranged in a filtering plane PO₆ optically conjugate with an object focal plane PO₁ of the imaging microscope objective lens. The filtering device further comprises a set of optical components including at least one first rotatable mirror (512, 522), with the set of optical components being configured to generate a fluorescence image of the line of light on the slit and means for rotating said at least one first movable mirror, synchronized with the scan of the line of light, in order to superimpose the slit and the fluorescence image of said line of light at each instant.

More specifically, in the example of FIG. 5A, the plane PO₅ corresponds to a plane optically conjugate with an object focal plane PO₁ of the imaging microscope objective lens and that is thus included in a light sheet produced by scanning a line of light, for example, by means of an illumination device as described above. The scan of a fluorescence image of the line of light is schematically shown in the plane PO₅ in FIG. 5A by several images of lines of light seen in a cross-section plane perpendicular to their axis, with the scanning direction being schematically shown by a thick line arrow. The set of optical components in the example of FIG. 5A comprises groups of lenses 511 and 514, on the one hand, and 515 and 518, on the other hand, forming afocal and telecentric optical systems, for example. These groups of lenses comprise, for example, achromatic lenses such as doublets, for example. The set of optical components in the example of FIG. 5A also comprises mirrors 512, 513, 516, 517, including, in this example, rotatable mirrors 512 and 517, for example, galvanometric mirrors, arranged in pupil planes PP₄ and PP₅, respectively. The mirrors are oriented, for example, at 45° relative to the optical axis of the spatial filtering device, returning the light at 90° by reflection. The fixed folding mirrors 513 and 516, which are oriented, for example, at 45° relative to the optical axis, allow the optical axis to be folded in a direction that allows, for example, an optical axis to be predominantly retained in a single direction for the spatial filtering device. These folding mirrors are provided, for example, with a metal-type treatment providing significant reflectivity over a very wide spectral band, or are provided with a dielectric-type treatment providing better reflectivity than that of the metal treatment but over a limited spectral band.

The group made up of the lenses 511 and 514 allows an optical conjugation to be provided between the planes PO₅ and PO₆, and the group made up of the lenses 515 and 518 allows an optical conjugation to be provided between the plane PO₆ and an intermediate focal plane PO₇, which itself is conjugate with the analysis detection plane PO₄ of the detector 248 of the wavefront analysis device by means of the lens 242 and of the microlenses of the matrix of microlenses arranged in the pupil plane PP₃ (see also FIG. 2). The pupil plane PP₄ in FIG. 5A is an optically conjugate plane of the pupil plane PP₁ of the imaging microscope objective lens 210 (see FIG. 2). When the wavefront correction device is connected to the microscopy imaging system, the optical conjugation between the pupil planes PP₁ and PP₄ is carried out, for example, by means of the lenses 212, 231, 241 (see FIG. 2) and 511. The pupil planes PP₅ and PP₄ are planes optically conjugate with the plane PP₃, the conjugation between PP₄ and PP₅ is carried out by the lenses 514 and 515 forming an afocal and telecentric system, and the conjugation between PP₅ and PP₃ is carried out by the lenses 518 and 242 forming an afocal and telecentric system, with these 2 afocal and telecentric systems comprising achromatic doublets, for example. Thus, the planes PO₄, PO₅, PO₆ and PO₇ are optically conjugate with one another and with the focal plane of the imaging microscope objective lens PO₁ shown in FIG. 2, and the pupil planes PP₃, PP₄ and PP₅ are optically conjugate with one another and with the pupil plane PP₁ of the imaging microscope objective lens 210 shown in FIG. 2. The length (largest dimension) of the fixed slit 510 arranged in the plane PO₆ is parallel to the axis of the fluorescence image of the line of light. When the line of light is scanned by the illumination path, the first movable mirror 512 carries out an angular scan at the same time as the line of light is scanned, the amplitude of which is adjusted so as to produce a fixed image of the line of light in the vicinity of the slit 510. Thus, at each instant that the line of light is scanned, the slit 510 carries out in-line confocal spatial filtering of the fluorescence signal originating from the line of light. As a result, the fluorescence light transmitted by the slit only originates from a confocal volume defined by the features of the slit, which allows the fluorescence signal to be reduced that originates from various planes of the imaging plane of the imaging microscope objective lens 210 (FIG. 2), but also allows the thickness of the transmitted line of light to be reduced.

Still at the same time as the line of light is scanned by the illumination path, the second movable mirror 517 carries out angular scanning at the same time as the line of light is scanned and as the first movable mirror 512 is scanned, allowing reconstitution of the fluorescence image produced by the temporal succession of the fluorescence images of the line of light produced by scanning the line of light, in the intermediate focal plane PO₇ conjugate with the analysis detection plane, based on the temporal succession of the fluorescence images of the lines of light located in the vicinity of the slit 510. This reconstructed fluorescence image is then imaged using the optics 242 and the matrix of microlenses located in the plane PP₃ on the detector 248 located in the plane PO₄ of the wavefront device according to the present description. The detector 248 thus allows an image to be detected that is made up of multiple fluorescence images of the object arranged in an arrangement similar to the arrangement of the microlenses in the plane PP₃, with this image allowing a wavefront to be deduced therefrom by computing the relative mutual deviation of the images according to a method as described above, for example, an intercorrelation computation method.

The dimensions of the slit 510 can be selected in the same way as those of the slit described with reference to FIG. 4A.

In the example of FIG. 5B, the optics 521, 523, 526 and 527 are the respective equivalents of the optics 511, 514, 515 and 518 of FIG. 5A, and have substantially similar features. The various conjugations of planes identified by the same references signs are similar to those described in FIG. 5A. In this embodiment, a single rotatable mirror 522, for example, a galvanometric mirror of the same type as the mirrors 512 and 517 of FIG. 5A, is used. The folding mirrors 524 and 525, of the same type as the mirrors 513 and 516 of FIG. 5A, are positioned so as to return the light toward the movable mirror 522.

Thus, when the illumination path scans the line of light, the rotatable mirror 522 carries out an angular scan at the same time as the line of light is scanned, and whose amplitude is adjusted so as to produce a fixed image of the line of light in the vicinity of the slit 510, in particular by reflecting onto the first folding mirror 524. The second folding mirror 525 is oriented so as to return the light spatially filtered by the slit 510 toward the rotatable mirror 522, with this mirror thus carrying out a second scan allowing reconstitution of the fluorescence image produced by the temporal succession of the fluorescence images of the line of light produced by scanning the line of light, in the intermediate focal plane PO₇ conjugate with the analysis detection plane, based on the temporal succession of the fluorescence lines located in the vicinity of the slit 510. The selection criteria concerning the features of the slit 510, and in particular its width, are similar to those described with reference to FIG. 4A or FIG. 5A.

The spatial filtering device 52 constitutes an advantageous variation of the spatial filtering device 51, since it allows a single rotatable mirror to be used. This allows the optomechanical implementation of the spatial filtering device 52 to be rendered more compact than that of the spatial filtering device 51, minimizing the potential loss of performance of the spatial filtering device 51 linked to any alignment and synchronization defects, while reducing the implementation cost.

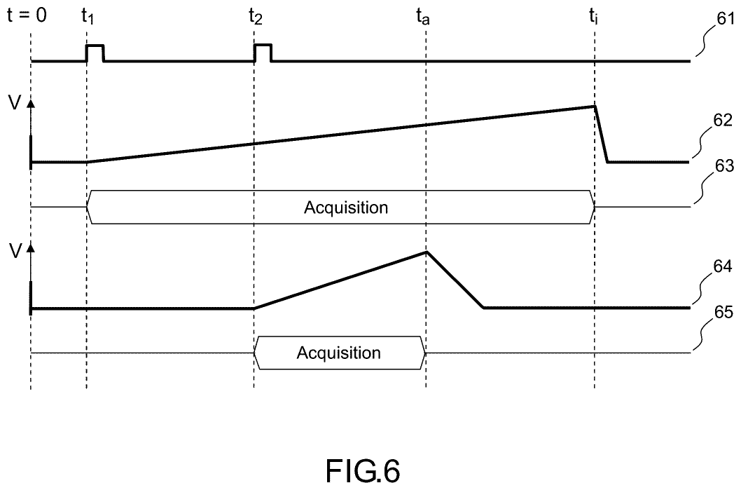

FIG. 6 schematically illustrates, according to an example that is provided by way of an illustration, a synchronization diagram of the main modules of a microscopy imaging system according to the present description, for example, but not exclusively, of the modules described with reference to FIGS. 2 to 5B.

As illustrated in FIG. 6, the signal 61 corresponds to a clock signal, configured to trigger the imaging and analysis detectors (respectively 220 and 248, FIG. 2), of the scanning system of the line of light of the illumination path and of the scanning system of the spatial filtering device as described in the present description. The trigger signal in this example comprises 2 square-wave logic voltage signals, with a first square-wave signal starting, for example, on its rising edge at time t₁ and a second square-wave signal starting, for example, on its rising edge at time t₂, with t₂ being temporally shifted with respect to t₁, for example.

In this example, the signal 62 corresponds to a signal for controlling the scan of the line of light of the illumination path. In the example of FIG. 6, this signal is a voltage ramp, and corresponds, for example, to the signal sent to the galvanometric type rotatable mirror 320 of FIG. 3A, or even to the signal sent to the piezoelectric type motorized translation system 364 of FIG. 3B, allowing the mirror 366 to be moved, in order to scan the line of light. The voltage received by this type of movable device actually allows the angle of rotation or the translation of said movable device to be controlled directly. Thus, the line of light is scanned between the times t₁ and tᵢ corresponding to the low and high levels of said voltage ramp in order to generate a light sheet corresponding to an imaging field.

The signal 63 schematically represents the time period over which the image of an object of interest is acquired, for example, using the imaging detector 220 in the embodiment of FIG. 2.

The signal 64 corresponds to an example of a signal for controlling the scanning of the spatial filtering device as described in the present description. For example, the signal 64 is a voltage ramp, and corresponds, for example, to the signal sent to the galvanometric type rotatable mirrors 512 and 517 of FIG. 5A and 522 of FIG. 5B, with the voltage received by this type of mirror allowing the angle of rotation of said mirror to be directly controlled. Thus, the analysis field is scanned between the times t₂ and tₐ corresponding to the low and high levels of said voltage ramp of the signal 64. The signal 64 can assume other forms, depending on whether controlling other types of scanning systems is involved. Thus, the signal 64 can assume other forms, depending on whether controlling a linear translation system of a mobile slit 40 in FIG. 4A is involved or a system for controlling the columns of a spatial intensity modulation device of the DMD type in FIG. 4B is involved, or any other controllable system for carrying out the scanning of the spatial filtering device as described in the present description.

The signal 65 schematically represents the period over which the acquisition of the analysis field of the wavefront analysis device according to the present invention is carried out, for example, using the analysis detector 248 (FIG. 2). The voltage signals 61, 62 and 64 are produced, for example, using an electronic synchronization system, such as, for example, an input/output electronic card providing both a logic output generating signals of the type shown in line 61 and two analogue outputs generating signals of the type shown in lines 62 and 64, with these various outputs being able to be precisely controlled over time relative to one another by said electronic synchronization system.

The electronic synchronization system can form a unit of the processing unit 250.

Thus, at the time t₁, the first slot for triggering the signal 61 allows synchronous triggering of the transmission of the signals 62 and 63, with the scan of the line of light of the illumination path controlled by the signal 62 and the acquisition by the imaging detector (220, FIG. 2) being carried out over the same duration tᵢ-t₁. This ensures, with suitable adjustment of the amplitude and the speed of the scan of the line of light of the illumination path, that the entire imaging field is covered by the scan of the illumination path.

This means that it is possible, for example, to benefit from the rolling shutter reading mode that is typically present on the fluorescence imaging cameras of light sheet fluorescence imaging devices, allowing the columns of pixels of the camera to be integrated in a manner that is sequential and synchronous with the scan of the line of light, which means that it is possible to benefit from confocal type detection on the camera.

At the instant t₂, the second slot for triggering the signal 61 allows synchronous triggering of the signals 64 and 65, with the one or more rotatable mirrors of the spatial filtering system controlled by the signal 64 and the acquisition of the analysis detector (248, FIG. 2) of the wavefront analysis device controlled by the signal 65 being carried out over the same duration tₐ-t₂. This ensures, with suitable adjustment of the amplitude and the speed of the scan of the one or more rotatable mirrors of the spatial filtering system, that the whole of the analysis field benefits from the effect of the spatial filtering system.

In the device according to the present invention, the size of the analysis field defined by the wavefront analyzer is generally significantly less than the size of the imaging field defined by the imaging camera. It is thus advantageous to start the acquisition of the image of the analysis field and the scan of the scanning device of the spatial filtering system after a delay in relation to the start of the acquisition of the image of the imaging field. This delay, t₂-t₁, is adjusted on the electronic synchronization system, taking into account the speed and amplitude features for scanning the illumination path, so as to make the instant t₂ correspond with the moment at which the scanned line of light is situated along a first edge of the analysis field.

All the signals described in FIG. 6 correspond to an acquisition sequence in a microscopy imaging system according to the present description.

Obviously, this sequence can be repeated over time for the sequential acquisition of images and measurements of the wavefront. Furthermore, other acquisition sequences are possible depending on the features of the modules of the microscopy imaging system.

Even though it has been described by means of a certain number of embodiments, the wavefront analysis device and the microscopy imaging systems and methods using the wavefront analysis device include various alternative embodiments, modifications and improvements that will be obvious to a person skilled in the art, with it being understood that these various alternative embodiments, modifications and improvements form part of the scope of the invention as defined by the following claims.

### BIBLIOGRAPHIC REFERENCES

[Ref. 1]: M. J. Booth et al., “Adaptive optics for fluorescence microscopy”, extracted from the document entitled, “orescence Microscopy: Super-resolution and other Novel Techniques”, by A Cornea et al., Academic Press, 2014.
[Ref. 2]: N. Ji, “Adaptive optical fluorescence microscopy”, Nature Methods 14, 374-380, 2017.
[Ref. 3]: U.S. Pat. No. 855,730 B2.
[Ref. 4]: Published patent application US 2015/0362713.
[Ref. 5]: K. Lawrence et al., “Scene-based Shack-Hartmann wavefront sensor for light-sheet microscopy”, Proc. SPIE 10502, Adaptive Optics and Wavefront Control for Biological Systems IV, 2018.
[Ref. 6]: Published patent application WO 2020/157265.
[Ref. 7]: O. E. Olarte et al., “Light-Sheet microscopy: a tutorial”, Advances in Optics and Photonics, Vol. 10, No. 1 (2018).
[Ref. 8] Dean et al., “Deconvolution-free subcellular imaging with axially swept light sheet microscopy”, Biophysical Journal, 108, 2807-2815, 2015.
[Ref. 9] Hedde et al., “Selective Plane Illumination Microscopy with a Light Sheet of uniform thickness formed by an electrically tunable lens”, Microscopy Research and Technique (2016).
[Ref. 10] Migliori et al., “Light-Sheet theta microscopy for rapid high-resolution imaging of large biological samples”, BMC Biology 16:57, 2018.

1. A method for fluorescence microscopy imaging of a volumetric and fluorescent object by means of a fluorescence microscopy imaging system with light sheet illumination, with said system comprising an imaging microscope objective lens with a pupil in a pupil plane and an optical axis, the method comprising:
illuminating the object with a light sheet through an illumination path comprising an illumination device, wherein illuminating comprises generating a line of light and scanning the line of light in an illumination plane substantially perpendicular to the optical axis of the imaging microscope objective lens in order to generate a light sheet, wherein a focal plane of said imaging microscope objective lens is included in said light sheet and wherein said light sheet generates an emission of fluorescence light by the object;
generating, through an imaging path comprising said imaging microscope objective lens and an imaging detector comprising an imaging detection plane, at least one first fluorescence image of an optical section of the object superimposed on the focal plane of said imaging microscope objective lens, wherein said at least one first fluorescence image is generated in a spectral imaging band;
analyzing a wavefront of the fluorescence light emitted by the object through an analysis path comprising said imaging microscope objective lens and a wavefront analysis device, wherein the wavefront analysis device comprises a two-dimensional detector with an analysis detection plane conjugate with said focal plane of the imaging microscope objective lens and a two-dimensional arrangement of microlenses, arranged in an analysis plane conjugate with said pupil plane, and wherein analyzing the wavefront comprises:
each microlens generating, on the analysis detection plane, a fluorescence image of a given analysis field of the object, located in a focal plane of the imaging microscope objective lens, wherein said fluorescence image is generated in a spectral analysis band;
spatially filtering the fluorescence light emitted by said analysis field by means of a spatial filtering device comprising a filtering element arranged in a filtering plane optically conjugate with the analysis detection plane, wherein the spatial filtering comprises a scan of said filtering element relative to a fluorescence image of said line of light formed in said filtering plane, synchronized with said scan of the line of light, so as to obtain a superposition of said filtering element and of said fluorescence image of the line of light at each instant;
processing the fluorescence images generated by the microlenses by means of a processing unit in order to determine a two-dimensional map of a characteristic parameter of the wavefront in said analysis plane;
correcting, based on the two-dimensional map of a characteristic parameter of the wavefront, at least a portion of the optical defects between said optical section of the object and said imaging detection plane, by means of a wavefront modulation device comprising a correction plane conjugate with the pupil plane.

2. The fluorescence microscopy imaging method as claimed in claim 1, wherein the filtering element comprises a movable slit and the spatial filtering of the fluorescence light emitted by said analysis field comprises a transverse movement of said slit, synchronized with the scan of the line of light.

3. The fluorescence microscopy imaging method as claimed in claim 1, wherein:
the filtering element comprises a fixed slit and the spatial filtering device further comprises a set of optical components including at least one first rotatable mirror, wherein the set of optical components is configured to generate a fluorescence image of the line of light on the slit, and wherein the spatial filtering of the fluorescence light emitted by said analysis field comprises:
rotating said at least one first movable mirror, synchronized with the scan of the line of light, in order to superimpose said slit and said fluorescence image of said line of light at each instant.

4. The fluorescence microscopy imaging method as claimed in claim 1, wherein the device for illuminating the illumination path comprises a laser emitting device for emitting a light beam and an optical illumination system with an optical illumination axis, wherein the optical illumination system is configured to generate a line of light from said light beam parallel to the optical illumination axis, and wherein the light sheet is generated by scanning the line of light in a direction perpendicular to the optical axis.

5. The fluorescence microscopy imaging method as claimed in claim 1, wherein the device for illuminating the illumination path comprises a laser emitting device for emitting a light beam and an optical illumination system with an optical illumination axis configured to generate a line of light from said light beam perpendicular to the optical illumination axis, with the light sheet being generated by scanning the line of light.

6. The fluorescence microscopy imaging method as claimed in claim 1, wherein:
determining said two-dimensional map comprises determining variations in the positions of the fluorescence images formed by the microlenses, wherein the variation in position of a fluorescence image formed by a microlens is measured relative to a reference position of a reference image, wherein the variation in position is determined by an operation between said image and said reference image, and wherein said operation is selected from among: an intercorrelation, a phase correlation, a sum of squared differences operation.

7. A wavefront correction device, configured to be connected to a fluorescence microscopy imaging system with light sheet illumination for implementing a method as claimed in claim 1, said fluorescence microscopy imaging system comprising an imaging path comprising an imaging microscope objective lens with a pupil in a pupil plane and an optical axis, and comprising an imaging detector with an imaging detection plane, and an illumination path comprising an illumination device configured to scan a line of light in an illumination plane substantially perpendicular to the optical axis in order to generate a light sheet, wherein the wavefront correction device comprises:
a wavefront analysis device comprising:
a two-dimensional detector comprising an analysis detection plane;
a two-dimensional arrangement of microlenses, arranged in an analysis plane, with each microlens being configured to generate, on the analysis detection plane when the wavefront correction device is connected to the microscopy imaging system, a fluorescence image of a given analysis field of the object located in a focal plane of the imaging microscope objective lens, with said fluorescence image being generated in a spectral analysis band;
a spatial filtering device configured to spatially filter fluorescence light emitted by said analysis field when the wavefront correction device is connected to the microscopy imaging system, wherein the spatial filtering device comprises a filtering element arranged in a filtering plane optically conjugate with the analysis detection plane and scanning means configured to scan said filtering element relative to a fluorescence image of said line of light formed in said filtering plane, synchronized with said scan of the line of light, so as to obtain a superposition of said filtering element and of said fluorescence image of the line of light at each instant;
a processing unit configured to determine a two-dimensional map of a characteristic parameter of the wavefront in said analysis plane based on all the images formed by the microlenses; wherein the wavefront correction device further comprises:
a wavefront modulation device comprising a correction plane, configured to correct at least a portion of the optical defects between said optical section of the object and said imaging detection plane based on the two-dimensional map of a characteristic parameter of the wavefront when the wavefront correction device is connected to the microscopy imaging system;
a first optical relay system configured to optically conjugate the pupil plane, the correction plane and the analysis plane when the wavefront correction device is connected to the microscopy imaging system;
a second optical relay system configured to optically conjugate the focal plane of the imaging microscope objective lens, the analysis detection plane, the imaging detection plane and the filtering plane when the wavefront correction device is connected to the microscopy imaging system.

8. The wavefront correction device as claimed in claim 7, wherein the filtering element of the confocal filtering device comprises a movable slit, and the scanning means are configured to generate a transverse movement of said slit, synchronized with the scan of the line of light.

9. The wavefront correction device as claimed in claim 8, wherein said movable slit is formed by a movable optomechanical element configured to transmit or reflect fluorescence light.

10. The wavefront correction device as claimed in claim 8, wherein said movable slit is formed by addressing a group of one or more rows (or columns) of a spatial intensity modulation device.

11. The wavefront correction device as claimed in claim 7, wherein the filtering element comprises a fixed slit and the spatial filtering device further comprises a set of optical components including at least one first rotatable mirror, and wherein:
the set of optical components is configured to generate a fluorescence image of the line of light on the slit; and
the scanning means are configured to generate a rotation of at least one first movable mirror, synchronized with the scan of the line of light, in order to superimpose said slit and said fluorescence image of said line of light at each instant.

12. The wavefront correction device as claimed in claim 8, wherein the width of the slit ranges between a minimum value equal to twice the diffraction limit of the imaging microscope objective lens multiplied by the optical magnification between the focal plane of the imaging microscope objective lens and the filtering plane in which the slit is arranged, and a maximum value equal to the width of the Rayleigh range corresponding to a Gaussian beam generating the fluorescence line of light and multiplied by the optical magnification between the focal plane of the imaging microscope objective lens and the filtering plane in which the slit is arranged.

13. A fluorescence microscopy imaging system for a volumetric and fluorescent object with light sheet illumination comprising:
an imaging path configured to generate at least one first image of an optical section of the object in a spectral imaging band, wherein said imaging path comprises an imaging microscope objective lens with a pupil in a pupil plane and an imaging detector comprising an imaging detection plane, and wherein said optical section is superimposed on a focal plane (PO1) of said imaging microscope objective lens,
an illumination path of the object comprising an illumination device configured to scan a line of light in an illumination plane substantially perpendicular to the optical axis of the imaging microscope objective lens in order to generate a light sheet, wherein a focal plane of said imaging microscope objective lens is included in said light sheet, and wherein said light sheet is configured to generate an emission of fluorescence light;
an analysis and correction path comprising said imaging microscope objective lens and a wavefront correction device as claimed in claim 7, configured to correct at least a portion of the optical defects between said optical section of the object and said imaging detection plane based on the two-dimensional map of a characteristic parameter of the wavefront.

14. The fluorescence microscopy imaging system as claimed in claim 13, wherein the device for illuminating the illumination path comprises a laser emitting device for emitting a light beam and an optical illumination system with an optical illumination axis, wherein the optical illumination system is configured to generate a line of light from said light beam parallel to the optical illumination axis, and wherein the light sheet is generated by scanning the line of light in a direction perpendicular to the optical illumination axis.

15. The fluorescence microscopy imaging system as claimed in claim 13, wherein the device for illuminating the illumination path comprises a laser emitting device for emitting a light beam and an optical illumination system with an optical illumination axis configured to generate a line of light from said collimated light beam perpendicular to the optical illumination axis, with the light sheet being generated by scanning the line of light.
